(19) United States
(12) Patent Application Publication
(10) Pub. No.: US 2020/0289898 A1
(43) Pub. Date: Sep. 17, 2020

(54) Spring Force Bolt Hanger

(71) Applicant: Metolius Mountain Products, Inc., Bend, OR (US)

(72) Inventor: Mark Wagner, Joshua Tree, CA (US)

(73) Assignee: Metolius Mountain Products, Inc., Bend, OR (US)

(21) Appl. No.: 16/794,395

(22) Filed: Feb. 19, 2020

Related U.S. Application Data
(60) Provisional application No. 62/818,281, filed on Mar. 14, 2019.

(51) Int. Cl. A63B 29/02; F16B 13/06

(52) U.S. Cl. CPC A63B 29/024; F16B 13/065

(57) ABSTRACT

An improved bolt hanger defines a hanger that exerts an outward force on the bolt that secures the hanger to a rock wall, urging the bolt outwardly under tension, and thereby helping to prevent the bolt from coming loose over time. The improved bolt hanger has a concave shape formed into it centered around the bolt hole. As the bolt is tightened into the bore in the rock, the head of the bolt (and/or an underlying washer) causes the concave portion to compress. This compression causes the concave portion of the hanger to exert an outward force on the bolt, which makes loosening the bolt more difficult. Furthermore, the hanger according to the present invention has a complex geometry on the rock-contacting surface that aids in the prevention of rotation of the hanger when under load. The bolt hanger may be used with a modified bolt adapted for use with the improved hanger.

### TECHNICAL FIELD

The present invention relates to protective and safety anchoring systems used in the field of climbing, and more particularly to a type of fixed protection known as a bolt hanger.

### BACKGROUND

A bolt hanger, also sometimes known as a fixed hanger, is a very common type of rock climbing protection that comprises a combination of a bolt and a hanger. Described very generally, bolt hangers are placed along climbing routes to provide fixed protection points. First, a bore is drilled into the rock. A bolt is extended through a hole in the hanger and the bolt is threaded into the bore in the rock and secured to thereby secure the hanger in place on the rock. The hanger has a second opening, a carabiner loop. A climber may clip a carabiner into the loop in the hanger and a climbing rope, or other type of protection such as a quickdraw or a sling, may be clipped into the carabiner.

As would be expected, there are many different types of bolt hangers, including a variety of bolts and hangers that are used with them. As for the bolts, the most common bolts that are used are either self-anchoring expansion bolts such as those commonly referred to as Rawl bolts. The Rawl bolts known as “five piece” bolts are known to be quite effective. Other types of bolts are secured to the rock with adhesive. The type of metal used in any particular bolt effects performance and different metals are appropriate for different locations. For example, a stainless steel bolt would be appropriate in a setting where corrosion is a concern, such as a rock wall near a body of salt water.

There are also many different types of hangers, including many different shapes and hangers of a variety of different types of metal. The preferred alloys are 304 stainless steel and 316 stainless steel.

When placing a bolt and hanger on a rock wall, the orientation of the carabiner loop on the hanger must be taken into consideration in relation to the forces that are applied to the hanger under load—such as when a climber falls and the hanger arrests the fall. It will be appreciated that significant force can be applied to the hanger, and bolt, when a climber falls. Depending upon the orientation of the hanger, the force applied to the hanger can cause downward pressure, and a rotational moment of the hanger around the bolt. The rotational force can cause the hanger to rotate relative to the bolt. This is undesirable because it can weaken the connection to the rock and the bolt hanger. If the rotational moment is such that the force is in the direction that would cause the hanger to rotate in a clockwise direction, then any force applied to the bolt by the hanger would be in the direction of tightening the bolt. On the other hand, if the rotational moment is such that the force is in the direction that would cause the hanger to rotate in a counterclockwise direction, then any force applied to the bolt by the hanger would be in the direction of loosening the bolt. Because this later situation is undesirable it is preferred, if possible, to orient the hanger so that the forces applied under load with an expected fall direction would tend to cause a clockwise rotational moment. Of course, to minimize the amount of the rotational force it is desirable to position the carabiner loop on the hanger as close as possible to the axis of the bolt—i.e., to reduce the length of the lever arm. Thus, stopping the rotation of the bolt hanger will reduce the chance that the bolt will become unthreaded from the expansion mechanism that is part of the bolt.

Moreover, when the hanger is secured to the rock wall the device may be “nested” in the wall when the bolt is tightened. This is especially true with relatively softer rock, and the nesting may help to overcome rotational forces when under load. The climber may use a hammer to break out some of the rock to increase the depth at which the peripheral edge of the hanger “nests” into the wall. Since bolts can be torqued up to 25 ft. lbs., the perimeter of the hanger may be indented, or “nested,” into the rock by the act of tightening the bolt.

Most commercially available hangers have a rock-facing surface that is essentially planar. Some manufacturers adopt anti-rotation features such as nubs that protrude from the rock-facing surface, and which are designed to press into the rock to prevent or minimize rotation. But even when a hanger is nested in a rock wall, rotation can occur when the hanger is under load, especially when the bolt is loose, so bolt loosening is an ever-present problem.

Because bolt hangers are fixed protection, they can stay in place in the rock for many years. Regardless of the type of bolt that is used to anchor a hanger to the rock, the bolts can loosen over time due to repeated loading or twisting, and also due to the innate environmental conditions such as freeze/thaw cycles, heat, etc. Bolts can also corrode and bend. A loose, corroded, or otherwise compromised bolt presents a serious safety concern since the bolt could break or be pulled out of the bore in the rock when under a heavy shock or load, such as when a climber falls. The same concerns apply to the hangers. Corrosion and wear over time may weaken the hanger and present safety problems.

As a result of the concerns detailed above about the risks associated with aging bolt hangers, several climbing organizations have programs in place to encourage the replacement of old, deteriorating bolts and hangers. For example, the American Safe Climbing Association (ASCA) encourages replacement of deteriorating bolts with stainless steel bolts. The ASCA's website at www.safeclimbing.org provides much information about the program.

In view of the known problems with bolt hangers, there is a need for a bolt hanger system that provides longer life and safety for a longer period of time in order to overcome the problems cause by, for instance, loosening bolts. The present invention is a hanger that is designed to overcome the problems associated with present hangers. More specifically, the improved bolt hanger described herein defines a hanger that exerts an outward force on the bolt, urging the bolt under tension outwardly, away from the rock, and thereby helps to prevent the bolt from coming loose over time. The improved bolt hanger has a concave shape formed into it centered around the bolt hole. As the bolt is tightened into the bore in the rock, the head of the bolt (and/or an underlying washer) causes the concave portion to compress. This compression causes the concave portion of the hanger to exert an outward force on the bolt, which makes loosening of the bolt more difficult. Furthermore, in an embodiment of the hanger according to the present invention the rock-facing surface of the hanger has a geometric configuration that aids in the prevention of rotation of the hanger when under load. The invention further comprises an improved expansion bolt adapted for use with the hanger according to the present invention also improves securement of the hanger to a rock wall.

### BRIEF DESCRIPTION OF THE DRAWINGS

The invention will be better understood and its numerous objects and advantages will be apparent by reference to the following detailed description of the invention when taken in conjunction with the following drawings.

FIG. 1A is an elevation view of the combination of a bolt and hanger in an assembly according to the present invention.

FIG. 1B is a perspective view of the bolt and hanger shown in FIG. 1, wherein the combination is rotated to a different angle.

FIG. 2 is a sectional elevation view of the bolt and hanger shown in FIG. 1A, taken along the line 2-2 of FIG. 1A, and illustrating the bolt and hanger secured to a rock.

FIG. 3 is a perspective view of a first embodiment of a hanger according to the present invention, shown in isolation.

FIG. 4 is top plan view of the hanger shown in FIG. 3.

FIG. 5 is a perspective and partially sectioned view of a hanger of the type shown in FIG. 3.

FIG. 6A is an elevation and partially sectioned view of a bolt and hanger according to the present invention in which the hanger is in an uncompressed condition.

FIG. 6B is a view similar to FIG. 6A except showing compression of the hanger as the bolt is tightened in the rock; in FIG. 6B the compression is shown somewhat exaggerated to illustrate the structure and function of aspects of the invention.

FIG. 7 is a bottom plan view of the rock-contacting surface of a hanger according to the present invention.

FIG. 8 is an elevation view of the bolt and hanger assembly according to the present invention.

FIG. 9A is a plan view of a first embodiment of a bolt sleeve according to the invention.

FIG. 9B is a plan view of a second embodiment of a bolt sleeve according to the invention.

FIG. 10A is a top plan view of a cupped washer for use with the present invention.

FIG. 10B is a perspective view of the cupped washer shown in FIG. 10A.

FIG. 11 is a top plan view of a hanger according to the invention and a cupped washer for use therewith shown next to the hanger, wherein the cupped washer is shown in an inverted position to illustrate the side of the cupped washer that faces the hanger in the assembly.

FIG. 12 is an elevation view of the hanger shown in FIG. 7, wherein the hanger is positioned with the base of the hanger on a flat rock surface.

### DETAILED DESCRIPTION OF ILLUSTRATED EMBODIMENTS

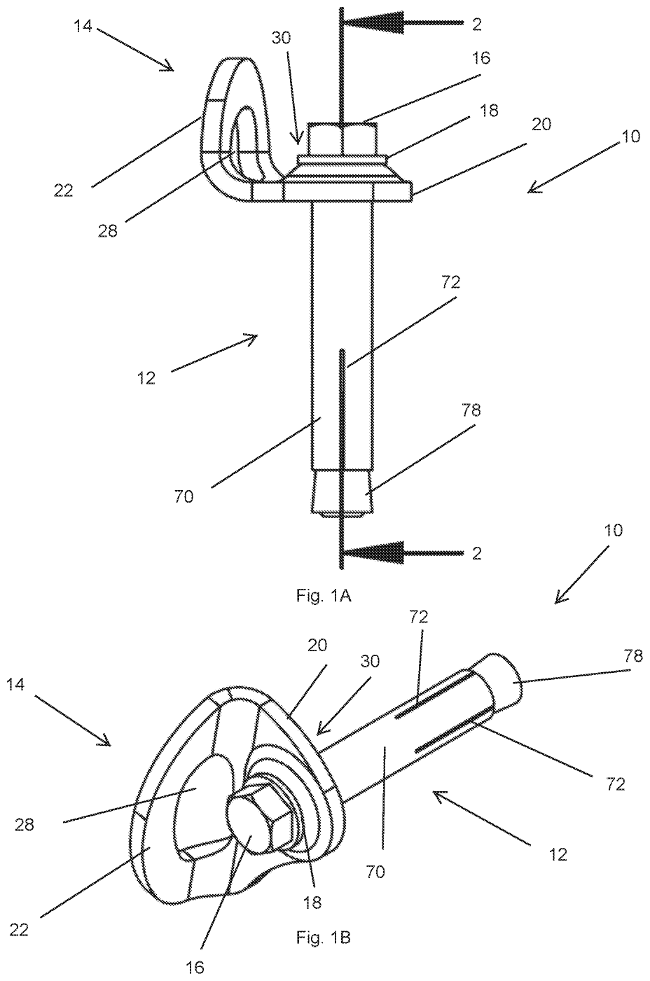

With reference now to the drawings, a bolt hanger 10 according to the invention is shown in various views. The bolt hanger 10 is an assembly comprising the combination of a bolt 12 and the hanger 14 and in some embodiments, a specially adapted washer 18. The hanger 14 according to the invention may advantageously be used with any number of bolts 12 that are on the market. The bolt 12 illustrated in FIG. 1 is a prior art stainless steel expansion bolt. It is similar to a well-known “Rawl 5 piece” bolt. The choice of what type bolt to use, what material, what length and what width, depends on considerations such as the environment where the bolt will be used, the type and hardness of the rock, etc. As noted, the hanger 14 of the invention may be used with many different types of bolts. The bolt 12 includes a head 16, and a washer 18 may be utilized. In some embodiments, detailed below, a modified cupped washer has been adapted for use with the hanger 14 according to the invention. And in some embodiments the present invention further comprises certain modifications to the bolt that improve functionality, longevity and safety of the bolt/hanger combination.

The hanger 14 is a monolithic, unitary metallic member that defines two segments that are oriented at an angle to one another. As used herein, the first portion is referred to base 20. Base 20 has two sides, an “upper” surface 21 and a “lower” surface 23. As detailed below, the lower surface 23 of hanger 14 defines the surface of the hanger that faces and makes contact with the rock when the bolt hanger 10 is bolted in place; the upper surface faces away from the rock. In the embodiment of FIG. 1 the lower surface 23 is essentially planar. In other embodiments described below, the lower surface defines a sloping geometry. A bore 24 is formed through base 20 and the bolt 12 extends through the bore 24 in the assembly. The second segment of hanger 14 is referred to herein as the carabiner loop portion 22. It is angularly disposed relative to base 20; and in the embodiments illustrated herein the angle between the base 20 and the carabiner loop portion 22 is around 90 degrees. It will be appreciated that the angle between these two segments may be varied according to need, and that the overall geometric shape of the hanger can vary widely from the embodiments illustrated.

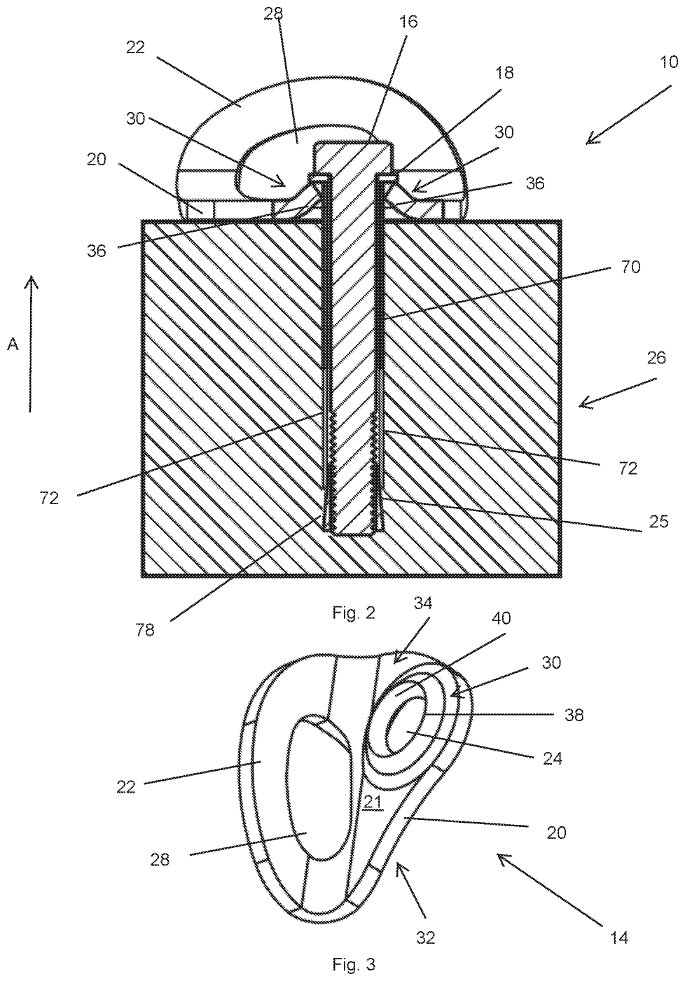

Turning to FIG. 2, hanger 14 is shown bolted to a bore 25 in a rock 26. It may be seen that lower surface 23 of base 20 faces and makes contact with the rock, and that the carabiner loop portion 22 is not in contact with the rock and extends away from it. The lower surface 23 is sometimes identified as the rock-facing surface 32, and the opposite surface of base 20, that is, upper surface 21, is at times identified as the outward-facing surface 34. The carabiner loop portion 22 has an opening that defines a carabiner loop 28. In use, a carabiner is attached to hanger 14 at carabiner loop 28. The preferred alloy for fabricating hanger 14 is 316 stainless steel but other alloys of stainless steel may also be used, such as 304 stainless steel. The bolt 12 shown in FIG. 2 is an expansion bolt and it is shown being used with a conventional washer 18.

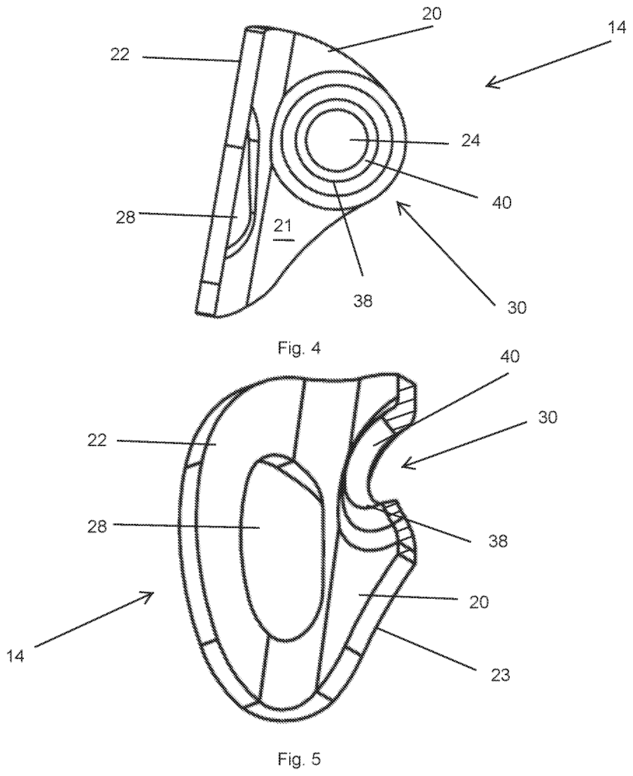

The area of base 20 that surrounds bore 24 defines a concave area that is identified with reference number 30. The concavity of concave area 30 extends in the direction from the lower surface 23 of hanger 14 toward the upper surface 21, as illustrated with arrow A in FIG. 2. The concave area 30 surrounds and is concentric with the axis through bore 24 and as may be seen in the cross-sectional view of FIG. 2, defines a frustoconical sidewall surface 36. With brief reference to FIGS. 4 and 5, it may be seen that the peripheral edge 38 of bore 24 is chamfered to define a beveled or chamfered edge 40 around the interior of the bore. As detailed below, he concave area 30 defines a spring that forces the bolt away from the rock. The concave area is typically formed with and appropriately formed punch and die, and using a hydraulic press.

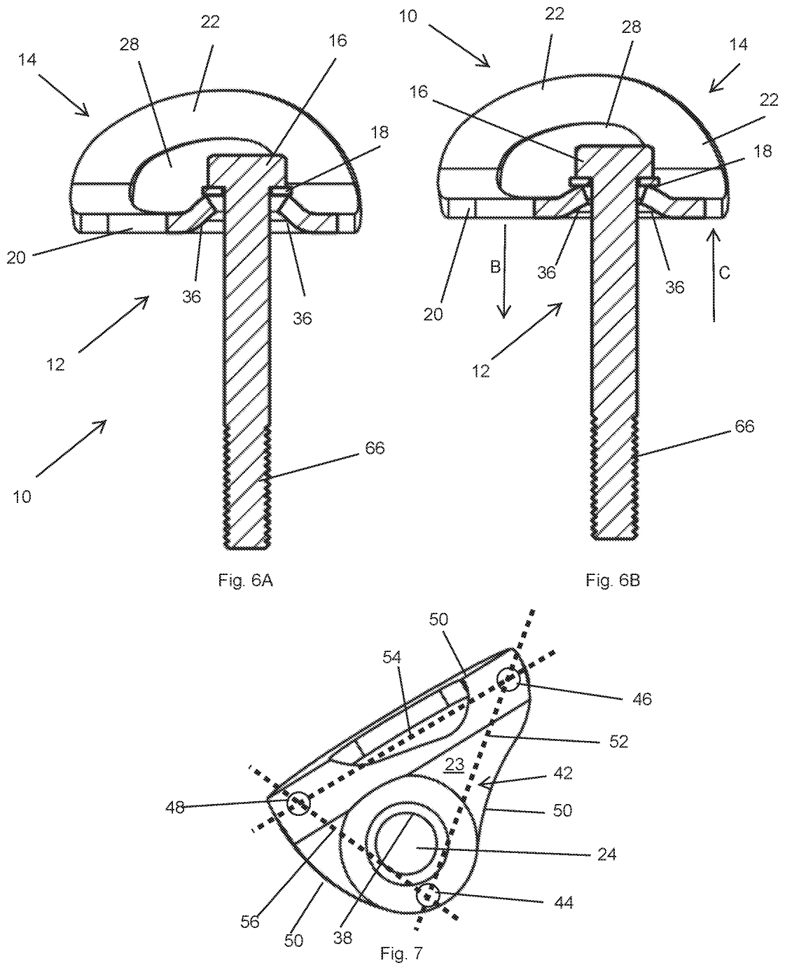

In one preferred embodiment of hanger 14 according to the present invention, the hanger includes a geometric configuration applied to the base 20 that is designed to improve the anti-rotation properties of the hanger, and which helps reduce the tendency of the bolt hanger to rotate or spin around the bolt, as described above, thereby contributing to preventing the bolt from loosening. The geometric configuration is best illustrated in FIG. 7, which shows the lower surface 23 of base 20. In the embodiment of FIG. 7, the lower surface 23 is not planar. Instead, the surface that surrounds the concave portion 30, and which extends to the perimeter 50 of base 20 is formed into an irregularly shaped funnel with gently sloping walls that run into the concave portion 30. The irregular funnel shape is identified generally with reference number 42. The lower surface 23 has three primary rock-contacting areas, essentially feet, shown generally in FIG. 7 with circles 44, 46 and 48 that come into contact first, before other parts of the hanger make contact with the rock. When the hanger is positioned against a rock, which for purposes of this description may be assumed to be planar, the hanger and the rock make contact at the rock-contacting areas 44, 46 and 48, generally positioned around the perimeter 50 in a triangular arrangement. Thus, if a line is drawn from rock-contacting area 44 to area 46 (dashed line 52), from area 46 to area 48 (dashed line 54), and from area 48 to area 44 (dashed line 56), as shown schematically in FIG. 7, the three lines 52-54-56 trace a triangle, in this instance a scalene triangle. Along each of those lines, the perimeter of the hanger is formed into an arc that curves away from the rock, that is, away from the lower surface 23. This may be seen in FIG. 12 where the hanger 14 is illustrated resting on a flat surface 58 (which represents a rock 26 having a planar upper surface), there is a gap 60 defined between the hanger and the surface 58 between contact areas 44 and 46. Similarly, a gap 62 is between the hanger and the surface 58 between contact areas 46 and 48, and a gap 64 between the hanger and the surface 58 between contact areas 48 and 44. The purpose of this geometry is detailed below. Thus, when the hanger 14 is lying on a planar surface such as in FIG. 12, it may be seen that the three rock-contacting areas are located below the remaining surface area of the lower surface 23 and lie in a common plane when all three are against a planar surface. In the non-compressed state (as in FIG. 12), the perimeter of the hanger between the rock-contacting areas curves away from the rock surface and do not make contact with it.

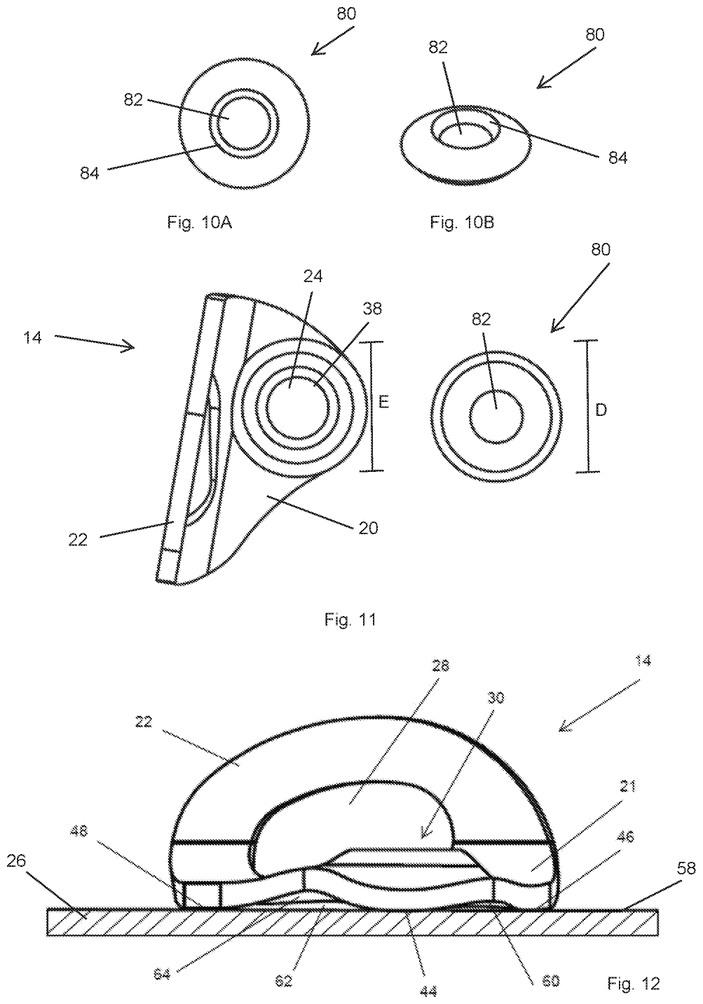

With reference now to FIGS. 1A and 1B, 8, 9A and 9B, and 10A and 10B, embodiments of a bolt 12 that has been modified for use with the hanger 14 according to the invention is shown. The bolt 65 that is shown in the drawings is a standard bolt that has a threaded shaft 66 and a head 68 at the proximate end. A sleeve 70 that has at least one, and typically two or more (see FIG. 1B), longitudinally extending slits 72 that extend from the distal end of the sleeve 70 to a point midway along the sleeve. The proximate end of sleeve 70 has been modified so that it flares outwardly at a flared rim 76. The diameter of the sleeve 70 is preferably very slightly less than the diameter of bore 24 through base 20 of hanger 14, but the diameter of the sleeve at flared rim 76 matches the diameter of the chamfered edge 40 of bore 24 in base 20. A threaded, tapered plug 78 is threaded onto the bolt 65 at the distal end 79 of the bolt. A cupped washer 80 is used with the bolt 65 of this embodiment and the washer has a diameter (line D in FIG. 11) that is equal to the diameter of the concave portion 30 of hanger 14 (line E in FIG. 11). The cupped washer 80 has a central bore 82 that is slightly greater in diameter than the diameter of the bolt 65 and a chamfered peripheral edge 84. As with the concave area 30, the cupped washer may be formed with an appropriate punch and die with a hydraulic press.

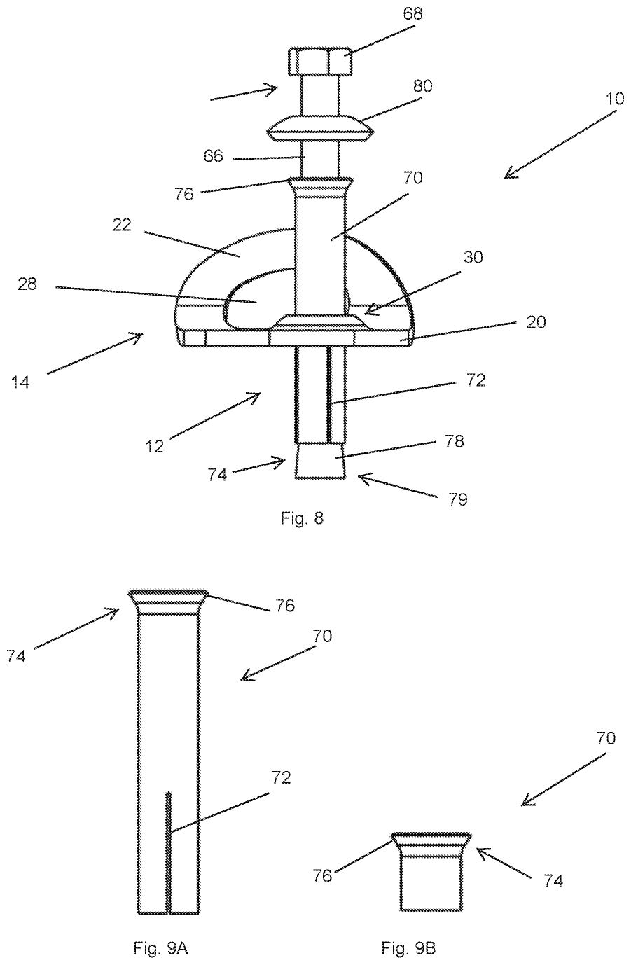

The assembled bolt hanger 10 is shown in a modified exploded view in FIG. 8. The cupped washer 80 is slid onto bolt 65 with the bolt extending through the central bore 82 of the washer, and such that the curvature of the cupped washer is oriented downwardly, toward the distal end 79 of the bolt. Optionally, as shown in FIGS. 1 and 2, a secondary washer 81 may be added to the bolt between the bolt head 68 and the cupped washer 80. The sleeve 70 is then slid onto the bolt such that the flared rim 76 is oriented toward the cupped washer 80. Hanger 14 is then assembled with the bolt by inserting the distal end of the bolt through bore 24 of base 20 of the hanger and such that the sleeve 70 slips into the bore. The tapered plug is then threaded onto the distal end 79 of bolt 65 such that the smaller diameter of the tapered plug is oriented toward the sleeve.

When the bolt hanger 10 is assembled as just described, it is ready to be installed into a bore in a rock. The hanger 14 is slid along the sleeve 70 until the chamfered edge 40 of bore 24 mates with flared rim 76 of sleeve 70. The hanger 14 and the sleeve 70 may then be slid along the bolt until the cupped washer 80 comes into contact with the upper margin of flared rim 76 and the base 20 around the concave area 30. At this point the threads on the distal end 79 of bolt 65 are exposed and the tapered plug is threaded onto the bolt.

The distal end of the assembled bolt hanger 10 is then inserted into a bore 25 in a rock 26. The bore 25 is sized so that the diameter of the threaded plug is slightly greater than the bore in the rock (see, e.g., FIG. 2)—it is typical that the bolt must be hammered into the bore. With the bolt fully inserted such that the lower side 23 of base 20 of the hanger abuts the rock surface, the bolt may be tightened. As the bolt rotates, the oversized tapered plug is bound to the rock and is drawn along the rotating bolt in the direction from the distal to the proximate end. As this happens the tapered plug slides beneath the distal end of the sleeve 70, with the plug between the bolt and the sleeve. As the plug translates along the bolt as the bolt is rotated, the plug causes the sleeve to expand along slits 72 and the sleeve is thus pressed tightly against the interior wall of the bore in the rock. The bolt is thus secured to the rock with as much as 25 ft. lbs. of torque.

Importantly, the bolt hanger 10 according to the invention provides an additional safety feature that helps to maintain the bolt tightly in the bore in the rock. Specifically, as the bolt is tightened as described in the previous paragraph, the head 68 is forced against cupped washer 80. With the hanger 14 fixed in position against the face of the rock wall, the lower, interior surface of the cupped washer exerts significant pressure against the flared rim 76 of sleeve 70. This drives the flared rim 76 into a tight, seating position in the chamfered edge 40 of bore 24. As the bolt head, cupped washer and flared rim are compressed together, the cupped washer comes into contact with the concave portion 30 around bore 24. Continuing tightening of the bolt causes deformation and compression of the base 20 at the concave portion 30, around bore 24. Because the steel that is used to fabricate hanger 14 is inherently somewhat springy and resilient, the compression causes the compressed concave portion to exert an outward pressure against the bolt head. That is, the bolt is placed under tension. This pressure/tension is maintained once the bolt is fully tightened and helps to prevent loosening of the bolt.

Reference is now made to FIGS. 6A and 6B. In these figures the sleeve 70 and cupped washer 80 are not shown in order to better view the compression of concave area 30 more clearly; a standard washer 18 is shown. In FIG. 6A the bolt 65 is not tightened. Head 68 is shown resting on a washer 18 that spans bore 24 at concave area 30. In FIG. 6A the bolt has been fully tightened into the rock, as described above. It may be seen that the concave area 30 has been compressed relative to the state of the concave area shown in FIG. 6A by pressure applied to the concave portion in the direction illustrated by arrow B in FIG. 6B. This compression results in significant force applied against the bolt head 68 in the opposite direction, shown with arrow C in FIG. 6B.

The geometric configuration of base 20 is yet another feature of a preferred embodiment of the invention that aids in preventing rotation of the hanger relative to the rock. Specifically, when a hanger 14 of the design shown in FIG. 12 is used with the bolt and washer described above, the three rock contacting areas 44, 46 and 48 are driven with significant force against the face 58 of the rock as the bolt is tightened in place. Many types of rock are relatively soft compared to the steel that is used to fabricate hanger 14. As such, as the bolt is tightened the three rock contacting areas dig into the underlying rock, thereby nesting the hanger in the rock and inhibiting rotation of the hanger relative to the rock. Even in very hard types of rock, the three rock contacting areas provide substantially greater anti-rotation friction than a planar hanger or a hanger that has, for instance, bosses that protrude from the lower side of the hanger base. As the bolt is torqued to tighten the hanger in place the concave area 30 compresses into a spring-like mechanism. Moreover, the remainder of the base 20 may also be deformed, causing the funnel-shaped lower surface to compress toward the rock face. As this happens, the perimeter edges of the base 20 between the rock-contacting areas may be pressed into contact with the rock as well.

It will be appreciated by those of skill in the art that certain modification may be made to the various embodiments described above and shown in the drawings without departing from the scope of the claimed inventions. For example, in the embodiment of FIG. 7 the lower surface 23 of the base 20 of hanger 14 has three rock-contacting surfaces. With this embodiment, the number of such surfaces may be as few as one or greater than three. Moreover, the arrangement of the rock-contacting surfaces need not trace any geometry in particular, and the irregular funnel shape of the lower surface of the hanger may be arranged with different sloping surfaces from that shown. Also, the gaps between the rock-contacting surfaces 44, 46 and 48 may be accomplished with a hanger that has a planer perimeter 51 but in which the rock-contacting surfaces are defined by protrusions or bosses that extend from the lower surface of the hanger base.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. Rock climbing protection for fixing to a bore in a rock, comprising:
a hanger having first and second segments angularly oriented relative to one another, the first segment comprising a rock-contacting surface and an opposed surface, and the second segment defining a carabiner loop, wherein
the first segment has a bolt bore with a compressible concave portion surrounding and concentric with the bolt bore, the concavity extending in the direction from the rock-contacting surface toward the opposed surface.

2. The protection according to claim 1 wherein the concave portion exerts a force in the direction opposite the compression when the concave portion is compressed.

3. The protection according to claim 1 wherein when the hanger is in a first, non-compressed state the rock-contacting surface is non-planar.

4. The protection according to claim 3 in which the rock-contacting surface defines plural rock-contacting feet.

5. The protection according to claim 4 in which in the first, non-compressed state, the plural rock-contacting feet lie in a common plane.

6. The protection according to claim 5 wherein a perimeter of the first segment extending between each of the plural rock-contacting feet defines arcuate edges that curve out of the common plane.

7. The protection according to claim 6 wherein when the hanger is in a second, compressed state caused when pressure is applied to the opposed surface of the first segment in the direction from the opposed surface toward the rock-contacting surface.

8. The protection according to claim 1 in which the rock-contacting surface of the first segment defines an irregular funnel shape that slopes from a perimeter of the first segment toward the concave portion.

9. The protection according to claim 1 including an expansion bolt extending through the bolt bore, the expansion bolt including a head that is adapted for exerting pressure on the concave portion on the opposed surface of the first segment.

10. The protection according to claim 9 including an expandable sleeve surrounding the expansion bolt and having a flared rim at a proximate end of the sleeve, the flared rim located between the head and first segment, and a tapered plug threaded onto a distal end of the expansion bolt.

11. The protection according to claim 10 further including a cupped washer between the head and the flared rim.

12. The protection according to claim 11 in which when the distal end of the bolt is inserted into the bore in the rock, the rock-contacting surface makes contact with the rock and the bolt is tightened, the tapered plug translates toward the head and thereby expands the expandable sleeve to secure the bolt in the bore, and the cupped washer applies pressure to and compresses the concave area, resulting in tension being applied to the head of the bolt, urging the bolt away from the hanger.

13. A method of securing a hanger to a rock having a bore formed therein, wherein the hanger is defined by first and second segments angularly oriented relative to one another, the first segment comprising a rock-contacting surface and an opposed surface and a bore through the first segment, and the second segment defining a carabiner loop, the method comprising the steps of:
a. extending a bolt through the bore and into the bore in the rock;
b. securing the bolt to the bore in the rock; and
c. causing tension to be applied to the bolt as it is secured to the bore in the rock

14. The method according to claim 13 wherein step c. includes the step of compressing a concave portion of the first segment surrounding the bore through the first segment.

15. The combination of a hanger and a bolt, comprising:
a hanger having first and second segments angularly oriented relative to one another, the first segment comprising a rock-contacting surface and an opposed surface, and the second segment defining a carabiner loop, the first segment having a bolt bore with a compressible concave portion surrounding and concentric with the bolt bore, the concavity extending in the direction from the rock-contacting surface toward the opposed surface;
a bolt extending through the bolt bore, the expansion bolt including a head that is adapted for exerting pressure on and compress the concave portion on the opposed surface of the first segment.

16. The combination according to claim 15 further including an expandable sleeve surrounding the bolt and having a flared rim at a proximate end of the sleeve, the flared rim located between the head and the opposed surface of the first segment, and a tapered plug threaded onto a distal end of the expansion bolt.

17. The combination according to claim 16 further including a cupped washer between the head and the flared rim.

18. The combination according to claim 17 in which the rock-contacting surface defines plural rock-contacting feet that are in a common plane.

19. The combination according to claim 18 wherein a perimeter of the first segment extending between each of the plural rock-contacting feet defines arcuate edges that curve out of the common plane.

20. The combination according to claim 15 in which the rock-contacting surface of the first segment defines an irregular funnel shape that slopes from a perimeter of the first segment toward the concave portion.
